(19) United States
(12) Patent Application Publication
(10) Pub. No.: US 2026/0159416 A1
(43) Pub. Date: Jun. 11, 2026

(54) PRECURSOR OF CATHODE ACTIVE SUBSTANCE OF NONAQUEOUS ELECTROLYTE SECONDARY BATTERY, AND CATHODE ACTIVE SUBSTANCE OF NONAQUEOUS ELECTROLYTE SECONDARY BATTERY

(71) Applicant: TANAKA CHEMICAL CORPORATION, Fukui (JP)

(72) Inventors: Kenta OZAWA, Fukui (JP); Hikaru HAYASHI, Fukui (JP)

(73) Assignee: TANAKA CHEMICAL CORPORATION, Fukui (JP)

(21) Appl. No.: 19/407,729

(22) Filed: Dec. 3, 2025

(30) Foreign Application Priority Data
Dec. 6, 2024 (JP) 2024-214022

(51) Int. Cl. C01G 53/84; H01M 4/525

(52) U.S. Cl. CPC C01G 53/84; H01M 4/525; C01P 2004/61; C01P 2004/62; C01P 2006/40

(57) ABSTRACT

Provided is a precursor of a cathode active substance of a nonaqueous electrolyte secondary battery, including: secondary particles formed by aggregating a plurality of primary particles and 50 mol % or more of nickel atoms relative to a total amount of contained metal atoms, wherein a coefficient of variation (CV) of particle diameters of the primary particles is 0.50 or less, and wherein D50/PS1 is 15.00 or less, where PS1 is an average particle diameter of the primary particles and D50 is a particle diameter of the secondary particles at 50 vol % of a cumulative volume percentage.

### CROSS REFERENCE TO RELATED APPLICATIONS

The present application claims the benefit of foreign priority to Japanese Patent Application No. 2024-214022, filed on Dec. 6, 2024, which is incorporated herein by reference in its entirety.

### BACKGROUND

### Technical Field

The present disclosure relates to a precursor of a cathode active substance of a nonaqueous electrolyte secondary battery, and a cathode active substance of a nonaqueous electrolyte secondary battery.

### Description of the Related Art

In recent years, from the viewpoint of reducing environmental load, secondary batteries have been used in a wide range of fields, including portable devices such as mobile phones and portable personal computers, as well as vehicles that use or combine electricity as power sources. Examples of the secondary batteries include, for example, nonaqueous electrolyte secondary batteries such as lithium-ion secondary batteries. These nonaqueous electrolyte secondary batteries are suitable for miniaturization and weight reduction, and exhibit various excellent battery characteristics.

As a cathode active substance of the nonaqueous electrolyte secondary battery, one including secondary particles formed by aggregating primary particles has been known. For example, Japanese Patent Application Laid-Open No. 2009-081130 discloses a specific lithium transition metal-based compound powder for a positive electrode material of a lithium secondary battery, in which a ratio A/B of a median diameter A of secondary particles to an average diameter (average primary particle diameter B) is in a range of 8 to 100.

### SUMMARY

As the application fields of the nonaqueous electrolyte secondary batteries expand, improvement of discharge rate characteristics is required for nonaqueous electrolyte secondary batteries. The present disclosure relates to providing a cathode active substance that can improve discharge rate characteristics of a nonaqueous electrolyte secondary battery, and its precursor.

The present disclosure relates to, for example, a precursor of a cathode active substance of a nonaqueous electrolyte secondary battery, including: secondary particles formed by aggregating a plurality of primary particles, wherein the precursor includes 50 mol % or more of nickel atoms relative to a total amount of contained metal atoms, a coefficient of variation (CV) of particle diameters of the primary particles is 0.50 or less, and, regarding an average particle diameter of the primary particles (PS1) and a particle diameter of the secondary particles at 50 vol % of a cumulative volume percentage (D50), D50/PS1 is 15.00 or less.

According to an embodiment of the present disclosure, a cathode active substance that can improve discharge rate characteristics of a nonaqueous electrolyte secondary battery, and its precursor can be provided.

### DETAILED DESCRIPTION

The following lists exemplary aspects of the present disclosure.
[1] A precursor of a cathode active substance of a nonaqueous electrolyte secondary battery, including:
   secondary particles formed by aggregating a plurality of primary particles, and
   50 mol % or more of nickel atoms relative to a total amount of contained metal atoms,
wherein a coefficient of variation (CV) of particle diameters of the primary particles is 0.50 or less, and
wherein D50/PS1 is 15.00 or less, where PS1 is an average particle diameter of the primary particles and D50 is a particle diameter of the secondary particles at 50 vol % of a cumulative volume percentage.
[2] The precursor according to [1], wherein (D90-D10)/D50 is 1.0 or less, where:
D10 is a particle diameter of the secondary particles at 10 vol % of the cumulative volume percentage,
D50 is the particle diameter of the secondary particles at 50 vol % of the cumulative volume percentage, and
D90 is a particle diameter of the secondary particles at 90 vol % of the cumulative volume percentage.
[3] The precursor according to [1] or [2], wherein the precursor is a metal complex compound represented by a compositional formula (I) below:

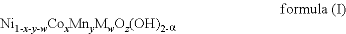

wherein x, y, w, z, and a satisfy 0≤x≤0.5, 0≤y≤0.5, 0≤w≤0.1, 0<x+y+w≤0.5, 0≤z≤3, −0.5≤α≤2, and α−z<2, and M is one or more kinds of addition elements selected from the group consisting of Fe, Cu, Ti, Mg, Al, Zn, Sn, Zr, Nb, Ga, W, Mo, B, and Si.
[4] The precursor according to any one of [1] to [3], wherein the D50 is 1 μm or more and 15 μm or less.
[5] A cathode active substance of a nonaqueous electrolyte secondary battery, said cathode active substance being a fired product of the precursor according to any one of [1] to [4] and a lithium compound.

### [Precursor of Cathode Active Substance]

Hereinafter, a precursor of a cathode active substance of a nonaqueous electrolyte secondary battery will be described in detail. The precursor of the present disclosure includes secondary particles formed by aggregating a plurality of primary particles. The particle shape of the precursor of the present disclosure is not particularly limited, and may have a wide variety of shapes. Examples of the shape of the primary particle can include, for example, a needle shape, a plate shape, and a columnar shape. Examples of the shape of the secondary particles can include, for example, a substantially spherical shape and a substantially oval shape.

The precursor of the present disclosure includes 50 mol % or more of nickel atoms relative to a total amount of contained metal atoms. The content of the nickel atoms relative to the total amount of the contained metal atoms in the precursor of the present disclosure is, for example, preferably 55 mol % or more, more preferably 60 mol % or more, and particularly preferably 80 mol % or more. Typically, the larger the content of the nickel atoms in the precursor is, the more advantageous the initial charge-discharge efficiency, the utilization rate, and the cycle characteristics are, and the less the cost of raw materials is. In addition, the content of the nickel atoms relative to the total amount of the contained metal atoms in the precursor of the present disclosure is, for example, preferably less than 100 mol %, more preferably 98 mol % or less, still more preferably 97 mol % or less, and particularly preferably 96 mol % or less. The lower limit value and the upper limit value of the content of the nickel atoms in the precursor of the present disclosure can be optionally combined within the disclosed ranges. For example, the content of the nickel atoms relative to the total amount of the contained metal atoms in the precursor of the present disclosure is preferably 50 mol % or more and less than 100 mol %, more preferably 55 mol % or more and 98 mol % or less, still more preferably 60 mol % or more and 97 mol % or less, and particularly preferably 80 mol % or more and 96 mol % or less.

The precursor of the present disclosure may be a metal complex compound represented by the following compositional formula (I).

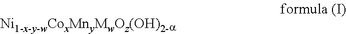

(In the formula, x, y, w, z, and α satisfy 0≤x≤0.5, 0≤y≤0.5, 0≤w≤0.1, 0<x+y+w≤0.5, 0≤z≤3, −0.5≤α≤2, and α−z<2, and M is one or more kinds of addition elements selected from the group consisting of Fe, Cu, Ti, Mg, Al, Zn, Sn, Zr, Nb, Ga, W, Mo, B, and Si.)

In the compositional formula (I), x preferably satisfies 0.01≤x≤0.4, more preferably satisfies 0.015≤x≤0.3, still more preferably satisfies 0.02≤x≤0.2, and particularly preferably satisfies 0.025≤x≤0.1.

In the compositional formula (I), y preferably satisfies 0.01≤y≤0.4, more preferably satisfies 0.02≤y≤0.3, still more preferably satisfies 0.03≤y≤0.2, and particularly preferably satisfies 0.04≤y≤0.1.

In the compositional formula (I), w preferably satisfies 0≤w≤0.05, more preferably satisfies 0≤w≤0.04, still more preferably satisfies 0≤w≤0.03, and particularly preferably satisfies 0≤w≤0.02.

The coefficient of variation (CV) of the particle diameters of the primary particles of the precursor of the present disclosure is 0.50 or less. Here, the particle diameters of the primary particles are measured by the following method. The image processing software “ImageJ” can be used for image analysis.

### (Method for Measuring Average Particle Diameter of Primary Particle (PS1))

### Measurement Range

In an SEM (scanning electron microscope) image of a secondary particle, the length of a line segment, which is on a perpendicular bisector of a long axis of the FIGURE surrounded by the outer edge of the secondary particle and is obtained by connecting two intersections of the perpendicular bisector and the outer edge, is defined as A. A portion surrounded by a virtual circle that has a center at the midpoint of the line segment and has a radius r calculated by the following formula is the measurement range.

$$r = A \times 3 / 8$$

### Measurement Method

Regarding all primary particles, which have a full length surrounded by the above-described virtual circle and are visible in the SEM image, a long diameter (dimension of a long axis) is measured. However, regarding primary particles that are partially hidden by another primary particle, the length of the range observed in the SEM image is measured. For example, when one primary particle is hidden by another primary particle that crosses it and is divided into two portions, the two portions are treated as two primary particles. The number average value of all long diameters measured as described above is defined as an average particle diameter of the primary particles (PS1).

The coefficient of variation (CV) of the particle diameters of the primary particles is a value obtained by dividing a standard deviation (o) of the particle diameters of the primary particles by a number average value (PS1). A small coefficient of variation (CV) means a small variation of the particle diameters of the primary particles. The coefficient of variation (CV) of the particle diameters of the primary particles of the precursor of the present disclosure is preferably 0.49 or less, more preferably 0.48 or less, still more preferably 0.47 or less, and particularly preferably 0.46 or less. A lower limit value of the coefficient of variation (CV) of the particle diameters of the primary particles is not particularly limited, but may be, for example, 0.1 or more. When the coefficient of variation (CV) of the particle diameters of the primary particles of the precursor of the present disclosure falls within appropriate ranges, discharge rate characteristics of a nonaqueous electrolyte secondary battery are advantageous.

In the precursor of the present disclosure, the average particle diameter of the primary particle (PS1) is not particularly limited. The average particle diameter of the primary particle (PS1) in the precursor of the present disclosure is, for example, preferably 0.2 μm or more and 0.8 μm or less, more preferably 0.3 μm or more and 0.5 μm or less, and still more preferably 0.4 μm or more and 0.45 μm or less.

In the precursor of the present disclosure, the particle diameter of the secondary particles at 50 vol % of the cumulative volume percentage (D50) (hereinafter, may be simply referred to as “D50”) is not particularly limited. In the precursor of the present disclosure, the D50 of the secondary particles may be 1 μm or more, may be 1.5 μm or more, may be 2 μm or more, may be 2.5 μm or more, or may be 3 μm or more, from the viewpoint of improving the packing density of the cathode active substance into a cathode. In the precursor of the present disclosure, the D50 of the secondary particles may be 15 μm or less, may be 10 μm or less, may be 8 μm or less, may be 6 μm or less, or may be 4.5 μm or less, from the viewpoint of improving the contact property with an electrolyte. The upper limit value and the lower limit value of the D50 of the secondary particles in the precursor of the present disclosure can be optionally combined within the disclosed ranges. For example, the D50 of the secondary particles in the precursor of the present disclosure may be 1 μm or more and 15 μm or less, may be 1.5 μm or more and 10 μm or less, may be 2 μm or more and 8 μm or less, may be 2.5 μm or more and 6 μm or less, or may be 3 μm or more and 4.5 μm or less. Note that the D50 is measured by a particle size distribution measurement apparatus using a laser diffraction·scattering method.

A value of the precursor of the present disclosure obtained by dividing the D50 by the average particle diameter of the primary particle (PS1), (D50/PS1) is 15 or less. A small value of the D50/PS1 means that the particle diameter of the primary particle relative to the particle diameter of the secondary particle is large. The D50/PS1 may be 14.00 or less, may be 13.00 or less, may be 12.00 or less, may be 11.00 or less, or may be 10.00 or less. The lower limit value of the D50/PS1 is not particularly limited, and may be for example, 4.00 or more. When the value of the D50/PS1 of the precursor of the present disclosure falls within appropriate ranges, the discharge rate characteristics of the nonaqueous electrolyte secondary battery are advantageous.

Regarding the D50 of the secondary particles, the particle diameter of the secondary particles at a cumulative volume percentage of 10 vol % (D10), and the particle diameter of the secondary particles at a cumulative volume percentage of 90 vol % of the precursor of the present disclosure (D90), (D90-D10)/D50 may be 1.0 or less. The (D90-D10)/D50 may be, for example, 0.8 or less, or may be 0.6 or less. Moreover, the (D90-D10)/D50 may be, for example, 0.3 or more, may be 0.35 or more, or may be 0.4 or more. The upper limit value and the lower limit value of the (D90-D10)/D50 can be optionally combined within the disclosed ranges. For example, the (D90-D10)/D50 is preferably 0.3 or more and 1.0 or less, more preferably 0.35 or more and 0.8 or less, and still more preferably 0.4 or more and 0.6 or less. When the value of the (D90-D10)/D50 falls within appropriate ranges, the cathode active substance to be obtained easily has excellent discharge rate characteristics. Note that the D10 and the D90 are measured by a particle size distribution measurement apparatus using a laser diffraction·scattering method in the similar manner as in the D50.

The tap density (TD) of the precursor of the present disclosure is not particularly limited. For example, the tap density (TD) of the precursor of the present disclosure may be 0.7 g/ml or more, may be 1 g/ml or more, or may be 1.2 g/ml or more, from the viewpoint of improving the production efficiency when the cathode active substance is produced. On the other hand, the tap density (TD) of the precursor of the present disclosure may be 1.9 g/ml or less, or may be 1.8 g/ml or less, for example, from the viewpoint of improving the contact property of the cathode active substance and the nonaqueous electrolyte. Note that the lower limit value and the upper limit value described above may be optionally combined within the disclosed ranges.

### [Production Method of Precursor]

Subsequently, the method for producing the precursor of the present disclosure will be described. The precursor of the present disclosure can be produced by a method that includes a reaction step of supplying a metal-containing aqueous solution that contains nickel, a complexing agent, and an alkaline aqueous solution to a reaction vessel for crystallization reaction, to obtain a nickel-containing hydroxide, a slurry extracting step of allowing a slurry containing the nickel-containing hydroxide to overflow from the reaction vessel to extract the slurry, a concentration step of concentrating, in a concentration vessel, the slurry extracted in the slurry extracting step, and a return step of returning the concentrated slurry to the reaction vessel.

The reaction step is a step of adding a metal-containing aqueous solution that contains nickel, an alkaline aqueous solution, and a complexing agent to a reaction vessel and mixing them, and subjecting them to co-precipitation reaction in a reaction solution, to obtain a nickel-containing hydroxide.

Specifically, by a co-precipitation method, a metal salt solution that contains a nickel salt (for example, a sulphate), and, as optional components, a cobalt salt (for example, a sulphate), a manganese salt (for example, a sulphate), and a salt of an addition element M (for example, a sulphate)(hereinafter, may be simply referred to as “metal-containing aqueous solution”), an alkaline aqueous solution, and a complexing agent are appropriately added to a reaction vessel, and are crystallized through neutralization reaction in the reaction vessel, to obtain a slurry suspension that contains a nickel-containing hydroxide. As a solvent of the suspension, for example, water is used.

In the reaction step, the metal concentration of the metal-containing aqueous solution supplied to the reaction vessel is preferably adjusted to 70 to 120 g/L.

The complexing agent is not particularly limited as long as it can form a complex with nickel, and, as optional components, cobalt, manganese, and an addition element M in an aqueous solution. Examples of the complexing agent include, for example, ammonium ion donors (ammonium sulfate, ammonium chloride, ammonium carbonate, ammonium fluoride, and the like), hydrazine, ethylenediaminetetraacetic acid, nitrilotriacetic acid, uracil diacetic acid, and glycine.

The alkaline aqueous solution is not particularly limited as long as the pH value of the aqueous solution is adjusted in co-precipitation. Examples of the alkaline aqueous solution include aqueous solutions of alkali metal hydroxides (for example, sodium hydroxide and potassium hydroxide).

When the metal-containing aqueous solution, the alkaline aqueous solution, and the complexing agent described above are supplied into the reaction vessel, nickel, and, as optional components, cobalt, manganese, and the addition element M undergo the crystallization reaction, to produce the nickel-containing hydroxide. In the crystallization reaction, while the temperature in the reaction vessel is controlled within a range of, for example, 20° C. to 70° C. and preferably 30° C. to 60° C. and the pH value in the reaction vessel is controlled within a range of, for example, pH 10 to pH 13 and preferably pH 10.5 to pH 12.5 based on the solution temperature of 40° C., the substances in the reaction vessel are appropriately stirred. Note that it is more preferable to initially control the pH value in the reaction vessel based on the solution temperature of 40° C. to be within a range of pH 11.4 to pH 13, and then to change it to within a range of pH 10 to pH 11.2 after a predetermined time passes from the start of the reaction.

A portion of the slurry containing the nickel-containing hydroxide obtained in the reaction step can be allowed to overflow from the reaction vessel to be extracted (slurry extracting step). The extracted slurry is concentrated in the concentration vessel (concentration step). The concentration step is a step of increasing the concentration of the nickel-containing hydroxide in the slurry. The concentration step may be performed by an optional solid liquid separation method (for example, filtration, precipitation, extraction, and the like). The slurry concentrated by the concentration step is returned to the reaction vessel (return step). Therefore, in the reaction vessel, while an unreacted metal-containing aqueous solution and the slurry returned by the return step are supplied together, the reaction step is performed. The slurry concentration (the concentration of the nickel-containing hydroxide) in the reaction vessel increases over time as the reaction proceeds. The reaction may be stopped after predetermined amounts of the metal-containing aqueous solution, the alkaline aqueous solution, and the complexing agent are charged and then a predetermined time passes.

In the above-described method, a ratio between a flow rate of the unreacted metal-containing aqueous solution supplied to the reaction vessel (flow rate X) and a flow rate of the slurry returned to the reaction vessel (flow rate Y) is adjusted, and the increasing rate of the slurry concentration in the reaction vessel is controlled, thereby the precursor of the present disclosure can be produced. For example, the flow rate X/flow rate Y may fall within a range of 0.001 to 1, preferably within a range of 0.005 to 0.5, and more preferably within a range of 0.007 to 0.3. In addition, for example, the increasing rate of the slurry concentration in the reaction vessel may be 4 g/(L·h) to 10 g/(L·h), and preferably 5 g/(L·h) to 8 g/(L·h) by adjusting the flow rate X/flow rate Y.

After the slurry containing the nickel-containing hydroxide obtained as described above is filtrated, the nickel-containing hydroxide is washed with an alkaline aqueous solution, it is separated into the solid phase and the liquid phase by the solid liquid separation, and the solid phase that contains the nickel-containing hydroxide can be obtained. If necessary, the solid phase that contains the nickel-containing hydroxide may be dried to obtain a nickel-containing hydroxide powder. If necessary, before the solid phase is dried, the solid phase may be washed with water or the like. The precursor of the present disclosure may be the nickel-containing hydroxide obtained in the above manner, or may be a nickel-containing oxide obtained by further oxidizing the nickel-containing hydroxide obtained in the above manner. Examples of the method for preparing the nickel-containing oxide from the nickel-containing hydroxide can include, for example, an oxidization treatment of performing firing under an atmosphere in which oxygen gas exists at a temperature of 300° C. or more and 800° C. or less for 1 hour or more and 10 hours or less.

### [Cathode Active Substance]

Next, a cathode active substance of a nonaqueous electrolyte secondary battery (hereinafter, may be simply referred to as “the cathode active substance of the present disclosure”), which is a fired product of the precursor of the present disclosure and a lithium compound, will be described. The cathode active substance of the present disclosure is an aspect in which the precursor of the present disclosure is fired with the lithium compound. The precursor of the present disclosure can be fired with the lithium compound to obtain a nonaqueous electrolyte secondary battery having excellent discharge rate characteristics.

The crystalline structure of the cathode active substance of the present disclosure is a layered structure, and is preferably a trigonal crystalline structure, a hexagonal crystalline structure, or a monoclinic crystalline structure from the viewpoint of obtaining a secondary battery having a high discharge capacity. The cathode active substance of the present disclosure can be used, for example, as a cathode active substance of a nonaqueous electrolyte secondary battery such as a lithium-ion secondary battery.

Next, a method for producing the cathode active substance of the present disclosure will be described. For example, in the method for producing the cathode active substance of the present disclosure, first, a lithium compound is added to the precursor of the present disclosure to prepare a mixture of the precursor of the present disclosure and the lithium compound. The lithium compound is not particularly limited as long as it is a compound including lithium, and examples of the lithium compound can include, for example, lithium carbonate and lithium hydroxide.

When the mixture is prepared, the lithium compound and the precursor of the present disclosure may be mixed so that, for example, a molar ratio of lithium of the lithium compound to the total amount of the contained metals (the total amount of nickel, and, as optional components, cobalt, manganese, and the addition element M) of the precursor of the present disclosure falls within a range of 1.00 or more and 1.10 or less.

Next, the above-described mixture can be fired to produce a cathode active substance. Examples of the firing condition include, for example, a firing temperature of 600° C. or more and 1000° C. or less, a rate of temperature increase of 50° C./h or more and 300° C./h or less, and a firing time of 5 hours or more and 20 hours or less. The firing may be performed, for example, under an air atmosphere or under an oxygen atmosphere. In addition, a firing furnace used for firing is not particularly limited, and examples of the firing furnace include a static box furnace and a continuous furnace of roller hearth type.

### [Nonaqueous Electrolyte Secondary Battery]

A cathode using the cathode active substance of the present disclosure, an anode, an electrolytic solution containing a predetermined electrolyte, and a separator can be prepared by a known method to assemble a nonaqueous electrolyte secondary battery.

The cathode includes a cathode current collector, and a cathode active substance layer using the cathode active substance of the present disclosure formed on a surface of the cathode current collector. The cathode active substance layer has the cathode active substance of the present disclosure, a binding agent (binder), and, if necessary, a conductive additive. The conductive additive is not particularly limited as long as it can be used for the nonaqueous electrolyte secondary battery, and, for example, carbon-based materials can be used. Examples of the carbon-based materials can include graphite powder, carbon black (for example, acetylene black), and fibrous carbon materials. The binding agent is not particularly limited, and, for example, thermoplastic resins can be used. Examples of the thermoplastic resin can include polyvinylidene fluoride (PVdF), butadiene rubber (BR), polyvinyl alcohol (PVA), carboxymethyl cellulose (CMC), polytetrafluoroethylene (PTFE), and combinations thereof. The cathode current collector is not particularly limited, but examples of the cathode current collector can include, for example, electrically conductive metal materials such as aluminum foil, nickel foil, and stainless steel.

The cathode is obtained by mixing, for example, a cathode active substance, a conductive additive, and a binding agent to prepare a cathode active substance slurry, filling a cathode current collector with the cathode active substance slurry by a known filling method, and drying the slurry, followed by rolling and fixing with a press or the like.

Examples of the anode can include an electrode in which an anode active substance layer including an anode active substance is supported on an anode current collector, and an electrode consisting of an anode active substance alone. The anode active substance is not particularly limited as long as it is usually used, and, for example, graphite such as natural graphite and artificial graphite, cokes, carbon black, pyrolytic carbons, carbon fibers, and fired bodies of organic polymer compounds can be used. The anode current collector is not particularly limited, and examples of the anode current collector can include, for example, metal materials such as copper foil, nickel foil, and stainless steel. The anode may be metal lithium.

To the anode active substance layer, a conductive additive, a binder, and the like may be further added if necessary. Examples of the conductive additive and the binder include the same as those used in the above-described cathode active substance layer.

The anode is obtained by mixing, for example, an anode active substance, and if necessary, a conductive additive, a binding agent, and water to prepare an anode active substance slurry, filling an anode current collector with the anode active substance slurry by a known filling method, and drying the slurry, followed by rolling and fixing with a press or the like.

Examples of the electrolyte contained in the nonaqueous electrolyte include LiClO₄, LiPF₆, LiAsF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (where, BOB is bis(oxalato) borate), LiFSI (where, FSI is bis(fluorosulfonyl)imide), lithium salts of lower aliphatic carboxylic acid, lithium salts of LiAlCl₄ and the like. These may be used alone or may be used in combination of two or more kinds.

As a dispersion medium of the electrolyte, for example, carbonates such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, 1,3-propanesultone, or those obtained by further introducing fluoro groups into these organic solvents (those in which one or more hydrogen atoms included in the organic solvents are substituted with fluorine atoms) can be used. These may be used alone or may be used in combination of two or more kinds.

In addition, in place of the electrolyte-containing electrolytic solution, a solid electrolyte may be used. As the solid electrolyte, for example, organic polymer electrolytes such as polyethylene oxide-based polymer compounds, or polymer compounds containing at least one or more kinds of polyorganosiloxane chains or polyoxyalkylene chains may be used. A so-called gel-type electrolyte, in which a nonaqueous electrolytic solution is held in a polymer compound, may also be used. Moreover, examples of the solid electrolyte include inorganic solid electrolytes containing sulfides such as Li₂S—SiS₂, Li₂S—GeS₂, Li₂S—P₂S₅, Li₂S—B₂S₃, Li₂S—SiS₂—Li₃PO₄, Li₂S—SiS₂—Li₂SO₄, and Li₂S—GeS₂—P₂S₅. These may be used alone or may be used in combination of two or more kinds.

The separator is not particularly limited, but for example, materials in the forms of porous membranes, nonwoven fabrics, woven fabrics, and the like, which are formed of polyolefin resins such as polyethylene and polypropylene, fluororesin, nitrogen-containing aromatic polymers can be used. These may be used alone or may be used in combination of two or more kinds.

### EXAMPLES

Next, the present disclosure will be described in more detail by way of Examples and the like, but the present disclosure is not limited to these Examples and the like.

### [Production of Precursor]

### Example 1

After water was added to a reaction vessel equipped with a stirring device of rotary type having a stirring blade and an overflow pipe, the temperature in the reaction vessel was raised to 40° C.

A nickel sulfate aqueous solution, a cobalt sulfate aqueous solution, and a manganese sulfate aqueous solution were mixed so that a molar ratio of nickel:cobalt:manganese was 92:3:5, to prepare a metal-containing aqueous solution that contained nickel.

Thereafter, the above-described metal-containing aqueous solution, an ammonium sulfate aqueous solution as a complexing agent, and a sodium hydroxide aqueous solution were continuously added into the reaction vessel under stirring, to obtain a slurry that contained nickel-containing hydroxide particles. At this time, while the above-described temperature in the reaction vessel was maintained and the pH in the reaction vessel was maintained at 11.6 based on the solution temperature of 40° C., the solutions were continuously stirred with a stirring machine. 0.5 hours after the start of reaction, the pH in the reaction vessel was changed to 11.0 based on the solution temperature of 40° C., and was maintained until the reaction stopped.

The generated slurry that contained nickel-containing hydroxide particles was allowed to overflow from the overflow pipe of the reaction vessel and was introduced into a concentration vessel. In the concentration vessel, the nickel-containing hydroxide particles were subjected to solid liquid separation, a supernatant was discharged to thereby concentrate the slurry, and the concentrated slurry was returned into the reaction vessel.

A ratio (flow rate X/flow rate Y) of a flow rate of the above-described metal-containing aqueous solution added dropwise to the reaction vessel (flow rate X) to a flow rate of the concentrated slurry returned into the reaction vessel (flow rate Y) was adjusted to 0.009. The increasing rate of the slurry concentration in the reaction vessel was 6.96 g/(L·h).

Charging each solution was stopped 67 hours after the start of the reaction, to stop the reaction. After the stop of the reaction, the slurry was extracted from the reaction vessel using a pump or the like, to extract the slurry that contained nickel-containing hydroxide particles to the outside of the system. After the extracted metal complex compound-containing slurry was subjected to solid liquid separation and the solid phase was washed with an alkaline aqueous solution, the solid phase was dried, to obtain a nickel-containing hydroxide of Example 1 (precursor of the cathode active substance).

### Example 2

After water was added to a reaction vessel equipped with a stirring device of rotary type having a stirring blade and an overflow pipe, the temperature in the reaction vessel was raised to 60° C.

A nickel sulfate aqueous solution, a cobalt sulfate aqueous solution, and a manganese sulfate aqueous solution were mixed so that a molar ratio of nickel:cobalt:manganese was 60:20:20, to prepare a metal-containing aqueous solution that contained nickel.

Thereafter, the above-described metal-containing aqueous solution, an ammonium sulfate aqueous solution as a complexing agent, and a sodium hydroxide aqueous solution were continuously added into the reaction vessel under stirring, to obtain a slurry that contained nickel-containing hydroxide particles. At this time, while the above-described temperature in the reaction vessel was maintained and the pH in the reaction vessel was maintained at 11.9 based on the solution temperature of 40° C., the solutions were continuously stirred with a stirring machine. 2 hours after the start of reaction, the pH in the reaction vessel was changed to 10.6 based on the solution temperature of 40° C., and was maintained until the reaction stopped.

The generated slurry that contained nickel-containing hydroxide particles was allowed to overflow from the overflow pipe of the reaction vessel and was introduced into a concentration vessel. In the concentration vessel, the nickel-containing hydroxide particles were subjected to solid liquid separation, a supernatant was discharged to thereby concentrate the slurry, and the concentrated slurry was returned into the reaction vessel.

A ratio of a flow rate of the above-described metal-containing aqueous solution added dropwise to the reaction vessel (flow rate X) to a flow rate of the concentrated slurry returned into the reaction vessel (flow rate Y)(flow rate X/flow rate Y) was adjusted to 0.367. The increasing rate of the slurry concentration in the reaction vessel was 6.15 g/(L·h).

Charging each solution was stopped 45 hours after the start of the reaction, to stop the reaction. The subsequent steps were performed in the similar manner as in Example 1, to obtain a nickel-containing hydroxide (precursor of the cathode active substance) of Example 2.

### Comparative Example 1

After water was added to a reaction vessel equipped with a stirring device of rotary type having a stirring blade and an overflow pipe, the temperature in the reaction vessel was raised to 70° C.

A nickel sulfate aqueous solution, a cobalt sulfate aqueous solution, and a manganese sulfate aqueous solution were mixed so that a molar ratio of nickel:cobalt:manganese was 85:10:5, to prepare a metal-containing aqueous solution that contained nickel.

Thereafter, the above-described metal-containing aqueous solution, an ammonium sulfate aqueous solution as a complexing agent, and a sodium hydroxide aqueous solution were continuously added into the reaction vessel under stirring, to obtain a slurry that contained nickel-containing hydroxide particles. At this time, while the above-described temperature in the reaction vessel was maintained and the pH in the reaction vessel was maintained at 12.1 based on the solution temperature of 40° C., the solutions were continuously stirred with a stirring machine.

The generated slurry that contained nickel-containing hydroxide particles was allowed to overflow from the overflow pipe of the reaction vessel and was extracted to the outside of the system. After the extracted metal complex compound-containing slurry was subjected to solid liquid separation and the solid phase was washed with an alkaline aqueous solution, the solid phase was dried, to obtain a nickel-containing hydroxide (precursor of the cathode active substance) of Comparative Example 1.

### Comparative Example 2

After water was added to a reaction vessel equipped with a stirring device of rotary type having a stirring blade and an overflow pipe, the temperature in the reaction vessel was raised to 70° C.

A nickel sulfate aqueous solution, a cobalt sulfate aqueous solution, and a manganese sulfate aqueous solution were mixed so that a molar ratio of nickel:cobalt:manganese was 94:4:2, to prepare a metal-containing aqueous solution that contained nickel.

Thereafter, the above-described metal-containing aqueous solution, an ammonium sulfate aqueous solution as a complexing agent, and a sodium hydroxide aqueous solution were continuously added into the reaction vessel under stirring, to obtain a slurry that contained nickel-containing hydroxide particles. At this time, while the above-described temperature in the reaction vessel was maintained and the pH in the reaction vessel was maintained at 11.6 based on the solution temperature of 40° C., the solutions were continuously stirred with a stirring machine. The subsequent steps were performed in the similar manner as in Comparative Example 1, to obtain a nickel-containing hydroxide (precursor of the cathode active substance) of Comparative Example 2.

### Comparative Example 3

After water was added to a reaction vessel equipped with a stirring device of rotary type having a stirring blade and an overflow pipe, the temperature in the reaction vessel was raised to 70° C.

A nickel sulfate aqueous solution, a cobalt sulfate aqueous solution, and a manganese sulfate aqueous solution were mixed so that a molar ratio of nickel:cobalt:manganese was 90:5:5, to prepare a metal-containing aqueous solution that contained nickel.

Thereafter, the above-described metal-containing aqueous solution, an ammonium sulfate aqueous solution as a complexing agent, and a sodium hydroxide aqueous solution were continuously added into the reaction vessel under stirring, to obtain a slurry that contained nickel-containing hydroxide particles. At this time, while the above-described temperature in the reaction vessel was maintained and the pH in the reaction vessel was maintained at 11.6 based on the solution temperature of 40° C., the solutions were continuously stirred with a stirring machine. The subsequent steps were performed in the similar manner as in Comparative Example 1, to obtain a nickel-containing hydroxide (precursor of the cathode active substance) of Comparative Example 3.

### Comparative Example 4

After water was added to a reaction vessel equipped with a stirring device of rotary type having a stirring blade and an overflow pipe, the temperature in the reaction vessel was raised to 60° C.

A nickel sulfate aqueous solution, a cobalt sulfate aqueous solution, and a manganese sulfate aqueous solution were mixed so that a molar ratio of nickel:cobalt:manganese was 60:20:20, to prepare a metal-containing aqueous solution that contained nickel.

Thereafter, the above-described metal-containing aqueous solution, an ammonium sulfate aqueous solution as a complexing agent, and a sodium hydroxide aqueous solution were continuously added into the reaction vessel under stirring, to obtain a slurry that contained nickel-containing hydroxide particles. At this time, while the above-described temperature in the reaction vessel was maintained and the pH in the reaction vessel was maintained at 11.8 based on the solution temperature of 40° C., the solutions were continuously stirred with a stirring machine. The subsequent steps were performed in the similar manner as in Comparative Example 1, to obtain a nickel-containing hydroxide (precursor of the cathode active substance) of Comparative Example 4.

The precursors of Examples and Comparative Examples, and the cathode active substances obtained from the precursors were evaluated as described below.

### (1) Compositional Analysis of Nickel-Containing Hydroxide

After the obtained nickel-containing hydroxide was dissolved in hydrochloric acid, the compositional analysis was performed using an inductively coupled plasma emission analysis device (Optima 8300 available from PerkinElmer Japan G.K.).

### (2) D10, D50, D90

The D10, D50, and D90 were measured using a particle size distribution measurement device (MT3300EXII available from MicrotracBEL Corp.)(the principle was the laser diffraction·scattering method). As the measurement conditions, water was used as a solvent, 1 ml of sodium hexametaphosphate as a dispersing agent was charged, the transmittance after the sample was charged was within a range of 80±2%, and no ultrasonic wave was generated. Moreover, as the solvent refractive index at the time of analysis, the refractive index of water of 1.333 was used. In the obtained cumulative particle size distribution curve, a value of the particle diameter at a point where the cumulative volume from the small particle side was 10% was defined as D10 (μm), a value of the particle diameter at a point where the cumulative volume from the small particle side was 50% was defined as D50 (μm), and a value of the particle diameter at a point where the cumulative volume from the small particle side was 90% was defined as D90 (μm).

### (3) Average Particle Diameter of Primary Particle (PS1), and Coefficient of Variation (CV) of the Particle Diameters of Primary Particle

Each of the nickel-containing hydroxide particles of Examples and Comparative Examples was observed with an SEM at a magnification of 20,000 times, to obtain an image of the secondary particle. In the obtained SEM image, the length of a line segment, which was on a perpendicular bisector of a long axis of the FIGURE surrounded by the outer edge of the secondary particle and was obtained by connecting two intersections of the perpendicular bisector and the outer edge, was defined as A. The measurement range was set to a portion surrounded by a virtual circle that had a center at the midpoint of the line segment and had a radius r calculated by the following formula.

$$r = A \times 3 / 8$$

Regarding all primary particles, which had a full length included in the above-described virtual circle and were visible in the SEM image, a long diameter (dimension of a long axis) was measured. However, regarding primary particles that were partially hidden by another primary particle, the length of the range observed in the SEM image was measured. As the image analysis, the image processing software “ImageJ” was used. The number average value of all long diameters measured as described above was defined as an average particle diameter of the primary particles (PS1). The coefficient of variation (CV) of the particle diameters of the primary particles was a value obtained by dividing a standard deviation (o) of the particle diameters of the primary particles by a number average value.

### (4) D50/PS1

A value of D50/PS1 was obtained by dividing the D50 of the secondary particles obtained in the above-described (2) by the average particle diameter of the primary particle (PS1) obtained in the above-described (3).

### (5) Tap Density (TD)

A tap denser (“KYT-4000” available from SEISHIN Enterprise Co., Ltd.) was used to measure the tap density by the constant mass measurement method. The measurement conditions of the tap density are as follows. The cell volume: 20 ml, the stroke length: 10 mm, and the number of tapping: 200 times.

### (6) Discharge Rate Characteristics

### Production of Cathode Active Substance

In the nickel-containing hydroxides of Examples and Comparative Examples, lithium hydroxide powder was added and mixed so that a molar ratio of Li/(Ni+Co+Mn) was 1.01, to obtain a mixture of nickel-containing hydroxide and lithium hydroxide. The obtained mixture was subjected to a firing treatment, to obtain a lithium metal complex oxide, which was used as the cathode active substance. The firing conditions were performed under an oxygen atmosphere, at a rate of temperature increase of 120° C./h and a firing temperature of 750° C. for 10 hours.

### Production of Cathode

The cathode active substance obtained as described above was used to produce a cathode, and the produced cathode was used to assemble a battery for evaluation. Specifically, the obtained cathode active substance, a conductive additive (acetylene black), and a binder (PVdF) were each mixed at a weight ratio of 92:5:3, and the obtained mixture was applied on a cathode current collector (aluminum foil), followed by drying and pressing. Thereafter, the substance adhered to the cathode current collector was used as a cathode.

### Production of Lithium-Ion Secondary Battery

The cathode obtained as described above, an anode (metal lithium), an electrolytic solution containing an electrolyte (LiPF₆)(a mixed solution in which ethylene carbonate, dimethyl carbonate, and ethyl methyl carbonate were mixed at a volume ratio of 30:35:35), and a separator (formed of polypropylene) were used to produce a lithium secondary battery.

### Discharge Rate Test

The produced lithium secondary battery was used to evaluate the discharge rate characteristics under the following conditions.
Test temperature: 25° C.
Charge maximum voltage 4.3 V, charge current 1 CA, constant current constant voltage
Discharge minimum voltage 2.5 V, discharge current 0.5 CA, 1 CA, or 5 CA, constant current discharge

The discharge capacity at 0.5 CA (0.5 C) was defined as an indicator for evaluating the discharge rate characteristics. Note that 0.5 C of 183 mAh/g or more was judged to be good.

In addition, the discharge capacity when the constant current discharge was performed at 1 CA and the discharge capacity when the constant current discharge was performed at 5 CA were used, and a value (5 C/1 C) determined by the following formula was defined as an indicator for discharge rate characteristics.

Discharge capacity at 5 CA/discharge capacity at 1 CA (formula)

Note that 5 C/1 C of 0.55 or more was judged to be good.

The above evaluation results are shown in Table 1.

TABLE 1

| | Composition | | (D90 − | | | Tap | | |
|---|---|---|---|---|---|---|---|---|
| | (molar ratio | | D10)/ | | | density | 0.5 C | |
| | Ni/Co/Mn) | D50[μm] | D50 | CV | D50/PS1 | [g/mL] | [mAh/g] | 5 C/1 C |
| Example 1 | 92/3/5 | 3.9 | 0.49 | 0.45 | 9.40 | 1.44 | 207 | 0.60 |
| Example 2 | 60/20/20 | 3.4 | 0.45 | 0.38 | 10.66 | 0.83 | 185 | 0.76 |
| Comparative | 85/10/5 | 3.7 | 1.59 | 0.69 | 8.05 | 1.41 | 197 | 0.51 |
| Example 1 | | | | | | | | |
| Comparative | 94/4/2 | 4.1 | 1.63 | 0.41 | 33.61 | 1.65 | 205 | 0.54 |
| Example 2 | | | | | | | | |
| Comparative | 90/5/5 | 4.0 | 1.60 | 0.56 | 30.76 | 1.71 | 204 | 0.51 |
| Example 3 | | | | | | | | |
| Comparative | 60/20/20 | 2.6 | 1.54 | 0.45 | 19.39 | 1.98 | 181 | 0.81 |
| Example 4 | | | | | | | | |

In Examples 1 and 2, the precursors were produced by a method including the concentration step of concentrating the slurry in the concentration vessel and the return step of returning the concentrated slurry to the reaction vessel. In Comparative Examples 1 to 4, the precursors were produced by a method that did not have the steps described above. The precursors obtained in Examples 1 and 2 had a coefficient of variation (CV) of the particle diameters of the primary particles of 0.50 or less and a D50 of the secondary particles/PS1 of the primary particles of 15.00 or less. This means that the particle diameters of the primary particles of the precursors obtained in Examples 1 and 2 were uniform, and the particle diameter of the primary particle relative to the particle diameter of the secondary particle was large. The secondary batteries including the cathode active substances obtained from such precursors had more excellent discharge rate characteristics than the secondary batteries including the cathode active substances obtained from the precursors of Comparative Examples. Particularly, the secondary batteries including the cathode active substances obtained from the precursors of Examples achieved high values both at 5 C/1 C and 0.5 C.

The secondary battery that includes the precursor and the cathode active substance of the present disclosure is suitably applicable in a wide range of fields, including portable devices and vehicles.

What is claimed is:

1. A precursor of a cathode active substance of a nonaqueous electrolyte secondary battery, comprising:
secondary particles formed by aggregating a plurality of primary particles, and
50 mol % or more of nickel atoms relative to a total amount of contained metal atoms,
wherein a coefficient of variation (CV) of particle diameters of the primary particles is 0.50 or less, and
wherein D50/PS1 is 15.00 or less, where PS1 is an average particle diameter of the primary particles and D50 is a particle diameter of the secondary particles at 50 vol % of a cumulative volume percentage.

2. The precursor according to claim 1, wherein (D90−D10)/D50 is 1.0 or less, where:
D10 is a particle diameter of the secondary particles at 10 vol % of the cumulative volume percentage,
D50 is the particle diameter of the secondary particles at 50 vol % of the cumulative volume percentage, and
D90 is a particle diameter of the secondary particles at 90 vol % of the cumulative volume percentage.

3. The precursor according to claim 1, wherein the precursor is a metal complex compound represented by a compositional formula (I) below:
Ni_{1-x-y-w}CoₓMn_{y}M_{w}O_{z}(OH)_{2-α} formula(I)
wherein x, y, w, z, and a satisfy 0≤x≤0.5, 0≤y≤0.5, 0≤w≤0.1, 0<x+y+w≤0.5, 0≤z≤3, −0.5≤α≤2, and α−z<2, and M is one or more kinds of addition elements selected from the group consisting of Fe, Cu, Ti, Mg, Al, Zn, Sn, Zr, Nb, Ga, W, Mo, B, and Si.

4. The precursor according to claim 1, wherein the D50 is 1 μm or more and 15 μm or less.

5. A cathode active substance of a nonaqueous electrolyte secondary battery, said cathode active substance being a fired product of the precursor according to claim 1 and a lithium compound.
